(19) United States
(12) Patent Application Publication
(10) Pub. No.: US 2011/0019054 A1
(43) Pub. Date: Jan. 27, 2011

(54) SOLID-STATE IMAGE SENSOR, IMAGING SYSTEM, AND METHOD OF DRIVING SOLID-STATE IMAGE SENSOR

(75) Inventor: Keijirou ITAKURA, Osaka (JP)

Correspondence Address: MCDERMOTT WILL & EMERY LLP, 600 13TH STREET, NW, WASHINGTON, DC, 20005-3096, US

(73) Assignee: PANASONIC CORPORATION, OSAKA (JP)

(21) Appl. No.: 12/900,210

(22) Filed: Oct. 7, 2010

Related U.S. Application Data
(63) Continuation of application No. PCT/JP2009/000802, filed on Feb. 24, 2009.

(30) Foreign Application Priority Data
Apr. 16, 2008 (JP) 2008-107026

(51) Int. Cl. H04N 5/335

(52) U.S. Cl. 348/311; 348/E05.091

(57) ABSTRACT

As nonvolatile memory is integrated on a substrate on which a solid-state image sensor device including: photoelectric converters arranged in rows and columns; vertical CCDs configured to transfer signal charge output from the photoelectric converters in the column direction; and a horizontal CCD configured to transfer signal charge output from the vertical CCDs in the row direction and output the signal charge as a video signal. The nonvolatile memory stores individual difference information indicating individual differences in dependence of saturation performance on a substrate voltage in the solid-state image sensor device, and outputs the stored individual difference information to the outside.

### CROSS-REFERENCE TO RELATED APPLICATION

This is a continuation of PCT International Application PCT/JP2009/000802 filed on Feb. 24, 2009, which claims priority to Japanese Patent Application No. 2008-107026 filed on Apr.16, 2008. The disclosures of these applications including the specifications, the drawings, and the claims are hereby incorporated by reference in their entirety.

### BACKGROUND

The present disclosure relates to so-called charge coupled device (CCD) solid-state image sensors, imaging systems capturing images in various capture modes with the solid-state image sensors, and methods for driving solid-state image sensors.

Some digital still cameras for taking photographs of still images, and some digital movie cameras for taking photographs of moving images employ CCD solid-state image sensors. In a CCD solid-state image sensor, in a period after a mechanical shutter has been closed and before signal charge obtained by image capture is read out, the amount of saturation signal charge held in the CCD solid-state image sensor decreases with time in some cases. Such a decrease in the amount of saturation signal charge is not preferable because performance including the S/N ratio or the dynamic range deteriorates. In view of this problem, in an example of a conventional imaging system, the substrate voltage is reduced while signal charge is read out, thereby increasing the amount of saturation signal charge in anticipation of a decrease in the amount of the saturation signal charge (see, for example, Japanese Patent Publication No. H10-150183).

In such a CCD solid-state image sensor, a voltage to be supplied to the substrate is controlled in the manner described above so as to adjust the amount of saturation signal charge.

### SUMMARY

Some imaging systems employing CCD solid-state image sensors are capable of capturing images in various capture modes. For example, some imaging systems are capable of selecting a capture mode of capturing a still image and a capture mode of capturing a moving image. Further, in some imaging systems, in capturing a moving image, in addition to a usual moving image capture mode, a user can select a pixel-binning moving image capture mode in which signal charge from a plurality of pixels is added together and the sum is output, and a high-speed mode (e.g., a capture mode in which the resolution is lower than that in the usual capture mode, but the frame rate is higher than that in the usual mode), for example. Further, in the case where an object to be captured is displayed on a monitor (e.g., a liquid-crystal display), an image can be captured in a decimation monitor mode in which a signal obtained by image capture with removal of predetermined pixels (i.e., decimation) is transferred.

Characteristics relating to saturation performance of CCD solid-state image sensors, such as the S/N ratio and the dynamic range required for the solid-state image sensors may vary among image capture modes. Accordingly, in such an imaging system, dependence of saturation performance on the substrate voltage may be utilized in such a manner that an appropriate voltage is applied to the substrate of the solid-state image sensor according to the capture mode to control the saturation level of the solid-state image sensor to an optimum level.

However, the size of recent CCD solid-state image sensors has been reduced, resulting in a large variation (i.e., large individual differences) in dependency of saturation performance on the substrate voltage. Consequently, in some cases, even when control of the substrate voltage for each image capture mode can obtain sufficient performance in one capture mode, desired performance of the solid-state image sensor cannot be obtained in other capture modes because of the individual differences.

It is therefore an object of the present invention to obtain desired saturation performance, irrespective of individual differences in dependency of saturation performance on the substrate voltage.

An aspect of the present invention is directed to an imaging system including:

a solid-state image sensor device including a plurality of photoelectric converters arranged in rows and columns and configured to perform photoelectric conversion on incident light to output signal charge, a plurality of vertical transfer units provided for the respective columns of the photoelectric converters and each configured to transfer, in a direction along the columns, signal charge output from part of the photoelectric converters in an associated one of the columns, and a horizontal transfer output unit connected to ends of the respective vertical transfer units and configured to transfer signal charge output from the vertical transfer units in a direction along the rows to output the signal charge as a video signal;

a nonvolatile storage unit integrated on a substrate on which the solid-state image sensor device is integrated, configured to store individual difference information indicating individual differences in dependence of saturation performance on a substrate voltage in the solid-state image sensor device and output the stored individual difference information;

a substrate-voltage application unit configured to apply a voltage to the substrate on which the solid-state image sensor device is integrated; and

a control unit configured to control a voltage to be applied from the substrate-voltage application unit for each capture mode, according to individual difference information read out from the nonvolatile storage unit.

In this configuration, individual difference information indicating individual differences in dependence of saturation performance on the substrate voltage is stored in the nonvolatile storage unit integrated on the substrate on which the solid-state image sensor device is integrated. Accordingly, the imaging system can easily utilize the individual difference information. Thus, in the imaging system, a substrate potential for desired saturation performance can be easily obtained.

Another aspect of the present invention is directed to a solid-state image sensor including:

a solid-state image sensor device including a plurality of photoelectric converters arranged in rows and columns and configured to perform photoelectric conversion on incident light to output signal charge, a plurality of vertical transfer units provided for the respective columns of the photoelectric converters and each configured to transfer, in a direction along the columns, signal charge output from part of the photoelectric converters in an associated one of the columns, and a horizontal transfer output unit connected to ends of the respective vertical transfer units and configured to transfer signal charge output from the vertical transfer units in a direction along the rows to output the signal charge as a video signal; and

a nonvolatile storage unit integrated on a substrate on which the solid-state image sensor device is integrated, configured to store individual difference information indicating differences in dependence of saturation performance on a substrate voltage in the solid-state image sensor device and output the stored individual difference information, wherein

the nonvolatile storage unit includes a plurality of memory cells each including a fuse.

This configuration enables individual difference information indicating individual differences in dependence of saturation performance on the substrate voltage to be output outside the solid-state image sensor. Accordingly, in an imaging system, for example, using this solid-state image sensor, a substrate potential for desired saturation performance can be easily obtained.

According to the present disclosure, a substrate potential for desired saturation performance can be easily obtained. Accordingly, desired saturation performance can be obtained, irrespective of individual differences (i.e., variation) in dependence of saturation performance on the substrate voltage. That is, maximum performance concerning saturation performance of the solid-state image sensor can be obtained, and further, a decrease in yield due to the variation can be reduced.

### BRIEF DESCRIPTION OF THE DRAWINGS

FIG. 1 is a block diagram illustrating a configuration of an imaging system according to a first embodiment of the present invention.

FIG. 2 is a block diagram illustrating an example of configurations of a nonvolatile memory and a memory data readout circuit according to the first embodiment.

FIG. 3 is a graph showing dependence of saturation performance on the substrate voltage in a solid-state image sensor device.

FIG. 4 is a timing chart showing voltages to be applied to a substrate at respective stages of image capture in a capture mode of a still image and timings of application of the voltages.

FIG. 5 shows examples of individual differences in the dependence curve for devices A and B.

FIG. 6 is a timing chart showing voltages to be applied to the substrate at respective stages of image capture in a capture mode of a moving image and timings of application of the voltages.

FIG. 7 is a block diagram illustrating a configuration of an imaging system according to a second embodiment of the present invention.

FIG. 8 is a block diagram illustrating a configuration of a charge injection unit.

FIG. 9 schematically shows an n⁺ region of a vertical CCD and potentials at the body of the vertical CCD.

FIG. 10 is a diagram showing voltages applied to gate electrodes (V1-V4) of the body of the vertical CCD and a stop gate VS.

FIG. 11 shows potentials in the vertical CCD and movement of charge in the vertical CCD.

### DETAILED DESCRIPTION

Embodiments of the present invention will be described hereinafter with reference to the drawings. The following embodiments are merely preferred examples in nature, and are not intended to limit the scope, applications, and use of the invention. In description of the embodiments, like reference characters are used to designate identical or equivalent elements, and explanation thereof is not repeated.

### First Embodiment

In a first embodiment of the present invention, an example of an imaging system capable of capturing images in a plurality of capture modes will be described. This imaging system is capable of selecting a capture mode in which a still image is captured and a capture mode in which a moving image is captured. In addition, in capturing moving images, moving images can be captured in various capture modes. For example, in capturing moving images, a user can select, in addition to a usual capture mode, a pixel-binning moving image capture mode in which signal charge from a plurality of pixels is added together and the sum is output and a high-speed mode (e.g., a capture mode in which the resolution is lower than that in the usual capture mode, but the frame rate is higher than that in the usual mode), for example. Further, in the case where an object to be captured is displayed on a monitor (e.g., a liquid-crystal display), an image can be captured in a decimation mode in which a signal obtained by image capture with removal of predetermined pixels (i.e., decimation) is transferred. In each of the capture modes, an appropriate voltage is applied to the substrate of the solid-state image sensor according to the capture mode to control the saturation level of the solid-state image sensor.

### Configuration of Imaging System

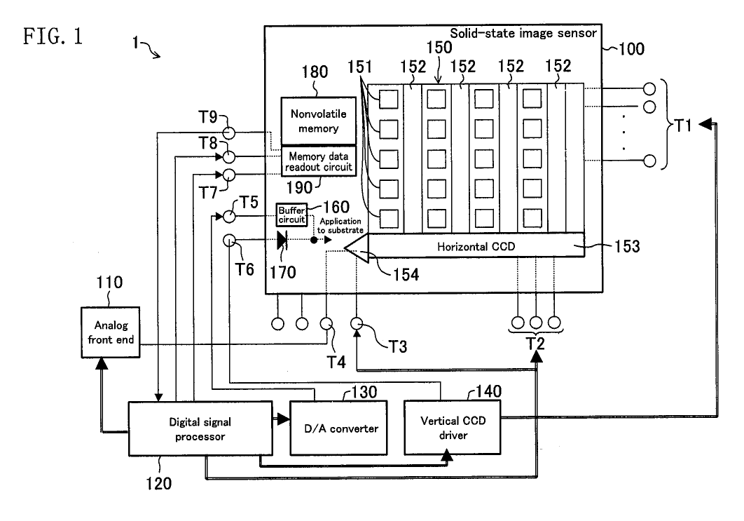

FIG. 1 is a block diagram illustrating a configuration of an imaging system 1 according to the first embodiment. As illustrated in FIG. 1, the imaging system 1 includes a solid-state image sensor 100, an analog front end 110, a digital signal processor 120 (a control unit), a digital-to-analog (D/A) converter 130 (a substrate-voltage application unit), and a vertical CCD driver 140. In FIG. 1, configurations of an optical system for forming an object image on the solid-state image sensor 100 and a recording system for recording a video signal obtained by image capture on a recording medium (e.g., an HDD or an optical disk), are not shown.

### Configuration of Solid-State Image Sensor 100

The solid-state image sensor 100 includes a solid-state image sensor device 150, a buffer circuit 160, a clamp diode 170, a nonvolatile memory 180 (a nonvolatile storage unit), and a memory data readout circuit 190.

The solid-state image sensor device 150 performs photoelectric conversion on incident light from an object, and outputs the obtained signal as a video signal. The solid-state image sensor device 150 may be a CCD image sensor of a so-called interline transfer type, for example. Specifically, the solid-state image sensor device 150 of this embodiment includes photoelectric converters 151, vertical CCDs 152 (vertical transfer units), a horizontal CCD 153, and an output amplifier 154.

Each of the photoelectric converters 151 is a device (e.g., a photodiode) performing photoelectric conversion on incident light to output signal charge. In the solid-state image sensor 100, the plurality of photoelectric converters 151 are arranged in rows and columns.

The vertical CCDs 152 are provided for the respective columns of the photoelectric converters 151. Each of the vertical CCDs 152 holds signal charge output from part of the photoelectric converters 151 located in an associated one of the columns, and transfers the signal charge in the column direction. Specifically, each of the vertical CCDs 152 has charge coupled devices (CCDs) respectively connected to the photoelectric converters 151 in the associated column through transfer gates (not shown), and holds signal charge transferred from the photoelectric converters 151. Each of the vertical CCDs 152 has a plurality of gate electrodes for controlling transfer of the charge held therein. Vertical transfer pulses (output from the vertical CCD driver 140) input through vertical CCD driver terminals Ti are given to the respective gate electrodes, and signal charge held according to the vertical transfer pulses is transferred in the column direction and output. In each of the vertical CCDs 152, an end from which signal charge is output will be referred to as a start end of transfer, and the opposite end will be referred to a terminal end of transfer. The outputs (i.e., the start ends) of the vertical CCDs 152 are connected to the horizontal CCD 153.

When receiving signal charge associated with one row from the vertical CCDs 152, the horizontal CCD 153 transfers input signal charge associated with one row, and outputs the signal charge to the output amplifier 154, while being controlled by a horizontal transfer pulse (output from the digital signal processor 120) input from a horizontal CCD drive terminal T2. This horizontal CCD 153 forms a horizontal transfer output unit together with the output amplifier 154.

The output amplifier 154 converts input signal charge into a voltage, and outputs the voltage, as a signal voltage for each pixel, to an outside part (e.g., to the analog front end 110 in this example) of the solid-state image sensor 100 through a signal output terminal T4. The output amplifier 154 is configured to receive a reset signal through a reset drive terminal T3.

As described above, the substrate voltage (hereinafter also referred to as a Vsub voltage) of the solid-state image sensor device 150 is controlled according to the capture mode. Thus, the solid-state image sensor 100 has a Vsub-voltage application terminal T5 for receiving a voltage to be applied to the substrate. The Vsub-voltage application terminal T5 is connected to the substrate of the solid-state image sensor device 150 through the buffer circuit 160. The buffer circuit 160 is provided in order to perform impedance conversion. The solid-state image sensor 100 also has an electric-shutter-pulse application terminal T6. The electric-shutter-pulse application terminal T6 is connected to the substrate of the solid-state image sensor device 150 through the clamp diode 170.

The clamp diode 170 has the function of superimposing a signal from the electric-shutter-pulse application terminal T6 on an output from the buffer circuit 160. To the electric-shutter-pulse application terminal T6, a pulse of a predetermined voltage (e.g., 20 V) (hereinafter referred to as an electric shutter pulse) is applied in capturing a still image (specifically, before light exposure) in order to change the charge values in the respective photoelectric converters 151 to zero at a time.

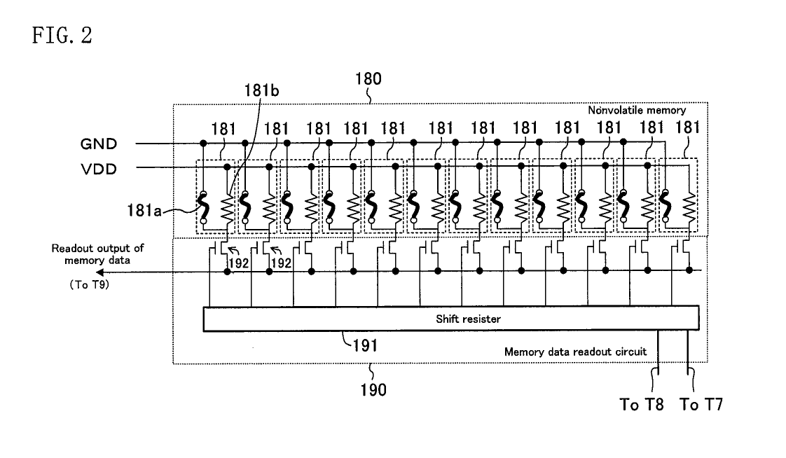

The nonvolatile memory 180 is a memory integrated on the substrate on which the solid-state image sensor device 150 is integrated, and is capable of holding stored data even after power supply to the solid-state image sensor 100 has been stopped. In this embodiment, a nonvolatile memory with a structure illustrated in FIG. 2 is employed as an example. In this example, the nonvolatile memory 180 is made of a plurality of memory cells 181 each including a fuse 181a and a pull-up resistor 181b, and stores a digital value of 1 or 0 depending on whether the fuse 181a is blown or not. The nonvolatile memory 180 with such a configuration can be fabricated in the process in which the solid-state image sensor device 150 is fabricated.

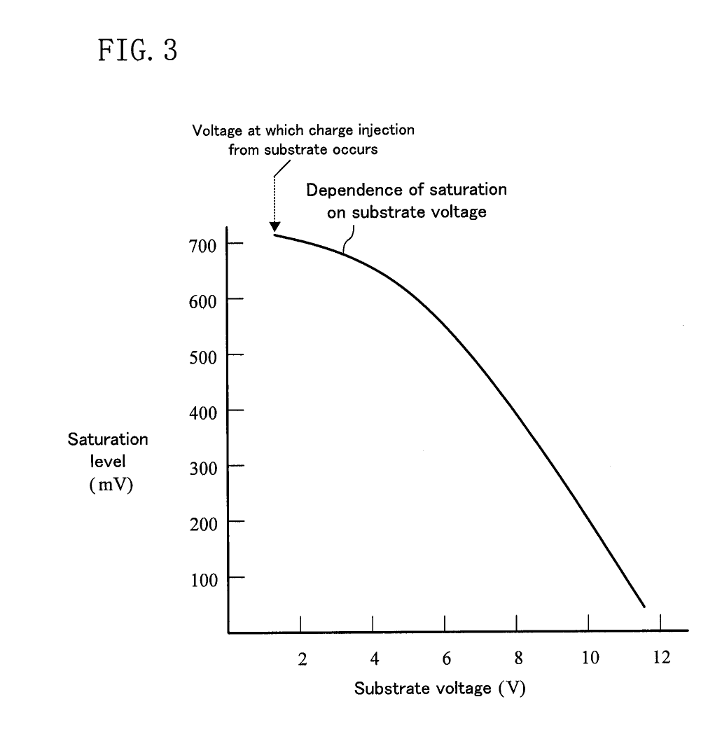

The nonvolatile memory 180 stores information (i.e., individual difference information) indicating individual differences in dependence of saturation performance on the substrate voltage in the solid-state image sensor device 150. The term “saturation” herein is a state in which an output signal voltage does not change any more after the amount of incident light exceeds a certain level. As shown in FIG. 3, the relationship between the substrate voltage (V) and the saturation level (mV) is shown as a curve (hereinafter referred to as a dependence curve) which is roughly convex upward. This dependence curve has individual differences, and differs among solid-state image sensor devices 150. In this embodiment, in fabrication of solid-state image sensors 100, dependence of saturation performance on the substrate voltage is measured with measurement apparatus for each sensor device, and coordinate values at portions of the dependence curve are stored in the nonvolatile memory 180. The individual difference information thus stored in the nonvolatile memory 180 is output to outside the solid-state image sensor 100 by the memory data readout circuit 190.

The memory data readout circuit 190 can be configured as illustrated in FIG. 2, for example. The memory data readout circuit 190 of this example includes a shift resister 191, and transistors 192 associated with the respective memory cells 181 of the nonvolatile memory 180. The drains of the transistors 192 are connected to the respective memory cells 181. The memory data readout circuit 190 receives a reset signal for resetting the shift resister 191 through a memory-data-readout-circuit reset terminal T7, and receives a clock signal for reading data through a memory-data-readout-clock input terminal T8. With this configuration, in reading data from the nonvolatile memory 180, the shift resister 191 is reset in response to the reset signal, then sequentially turns the transistors 192 on in synchronization with the clock signal, and outputs, as serial data, individual difference information stored in the nonvolatile memory 180 to outside the solid-state image sensor 100 through a memory-data-readout-clock input terminal T9.

### Peripheral Configuration of Solid-state Image Sensor 100

The analog front end 110 includes an amplification circuit, an A/D converter, and a noise removal circuit (none shown), converts a video signal (an analog signal) output from the output amplifier 154 into a digital signal, and outputs the digital signal to the digital signal processor 120.

The digital signal processor 120 serves as a timing generator. Based on a clock signal generated by this timing generator, the digital signal processor 120 controls the vertical CCD driver 140, the solid-state image sensor device 150, and the horizontal CCD 153. Specifically, in controlling the horizontal CCD 153, a horizontal transfer pulse is given to the horizontal CCD 153, thereby controlling transfer of signal charge. In addition, the digital signal processor 120 performs image processing and compression on a video signal (a digital value) output from the analog front end 110.

The above-described function of the digital signal processor 120 is also provided in a digital signal processor in a general imaging system. The digital signal processor 120 of this embodiment, however, has a feature in controlling the substrate voltage of the solid-state image sensor device 150. Specifically, based on individual difference information output from the nonvolatile memory 180, the digital signal processor 120 of this embodiment obtains a voltage to be applied to the substrate of the solid-state image sensor device 150 for each capture mode, and stores a digital value (hereinafter referred to as a control value) corresponding to the obtained voltage. In capturing an image, this control value is output to the D/A converter 130.

The D/A converter 130 converts the control value output from the digital signal processor 120 into a voltage, and inputs the voltage to the solid-state image sensor 100 through the Vsub-voltage application terminal T5. In this manner, the voltage corresponding to the control value is applied to the substrate of the solid-state image sensor device 150. That is, in this imaging system 1, even in the same capture mode, different substrate voltages are applied to different solid-state image sensors 100 (i.e., solid-state image sensor devices 150). Specific examples of substrate voltages for each capture mode will be described later. The vertical CCD driver 140 is controlled by the digital signal processor 120 to generate a vertical transfer pulse to be applied to the gate electrode of each of the vertical CCDs 152 in transferring signal charge. The vertical CCD driver 140 also generates an electric shutter pulse. The vertical transfer pulse and the electric shutter pulse are relatively high, as compared to other signals. Thus, the vertical CCD driver 140 for processing these signals are generally integrated on a chip different from a chip on which the digital signal processor 120 and the solid-state image sensor 100, for example, are integrated.

### Operation of Imaging System 1

### Readout of Individual Difference Information

In the imaging system 1, when the power is turned on, preparation of image capture starts, and predetermined initialization is performed. In this initialization, the digital signal processor 120 reads out individual difference information stored in the nonvolatile memory 180 through the memory data readout circuit 190 (a readout step). Specifically, first, the digital signal processor 120 inputs a reset signal to the shift resister 191 through the memory-data-readout-circuit reset terminal T7. Next, the digital signal processor 120 inputs a clock signal for data readout through the memory-data-readout-clock input terminal T8.

Thus, the shift resister 191 of the memory data readout circuit 190 is reset in response to the reset signal, and in synchronization with this clock signal, sequentially turns the transistors 192 on, and outputs, as serial data, individual difference information stored in the nonvolatile memory 180 to the digital signal processor 120 through the memory-data-readout-clock input terminal T9.

The thus-readout individual difference information is stored in the digital signal processor 120. Then, in each step (which will be described later) of image capture in each capture mode, the digital signal processor 120 obtains a voltage (a control value) to be applied to the substrate of the solid-state image sensor device 150 according to the readout individual difference information, and stores the information (a control value calculation step). The thus-obtained control value is used for each capture mode (e.g., capture of a still image or capture of a moving image).

### Capture of Still Image

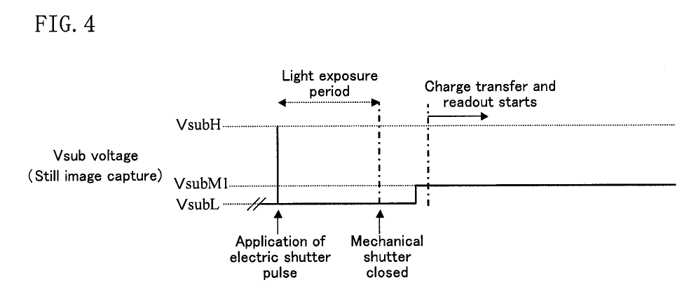

When a capture mode of a still image is selected, for example, the digital signal processor 120 sequentially outputs control values associated with respective stages of capture of the still image to the D/A converter 130, and controls a substrate voltage to be applied to the solid-state image sensor device 150 (a substrate voltage application step). FIG. 4 is a timing chart showing voltages to be applied to the substrate of the solid-state image sensor device 150 at respective stages of image capture in the capture mode of a still image and timings of application of the voltages. In this example, as shown in FIG. 4, in the capture mode of a still image, three types of voltages, i.e., VsubH, VsubM1, and VsubL, are applied to the substrate according to the stages of image capture.

When image capture starts, first, an electric shutter pulse is applied from the vertical CCD driver 140 controlled by the digital signal processor 120 to the solid-state image sensor device 150. Thus, charge values in the photoelectric converters 151 are changed to zero at a time. The substrate voltage applied at this timing is VsubH in FIG. 4. In this embodiment, VsubH is not changed in association with individual solid-state image sensor devices 150. This is because as long as VsubH is sufficiently high, charge values in the photoelectric converters 151 can be changed to zero, irrespective of individual differences in dependence of saturation performance on the substrate voltage.

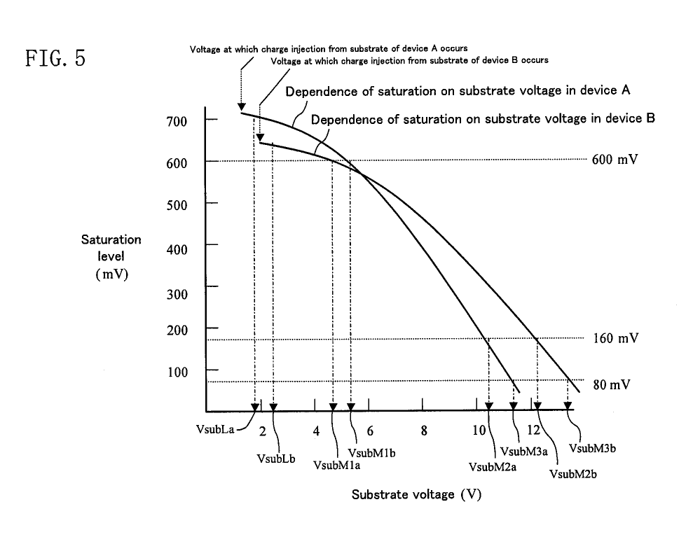

After the charge values in the photoelectric converters 151 have been changed to zero, light exposure starts. The voltage applied to the substrate at this timing is VsubL. In the light exposure, when VsubL is set such that the saturation level is at the maximum, the solid-state image sensor device 150 can be used in a highly sensitive state. To obtain this state, VsubL is as low as possible as shown in FIG. 3. The point on the dependence curve at which the dependence curve is the lowest in FIG. 3 is a substrate voltage (hereinafter referred to as a charge injection voltage) at which charge is injected from the substrate, and the solid-state image sensor device 150 cannot be used at this voltage. Thus, a voltage slightly higher than the charge injection voltage is defined as VsubL. FIG. 5 shows examples of individual differences of the dependence curves for devices A and B. As shown in FIG. 5, since the charge injection voltage has individual differences, the digital signal processor 120 calculates VsubL based on individual difference information in the control value calculation step, and outputs a control value to the D/A converter 130 at the timing shown in FIG. 4. In the example shown in FIG. 5, in the imaging system 1 including the device A, as VsubL, VsubLa is applied to the device A, whereas in the imaging system 1 including the device B, VsubLb is applied to the device B. Accordingly, even when the devices A and B have individual differences, the substrate voltages of the devices A and B can be set so as to have the highest sensitivities in the light exposure.

When the mechanical shutter is closed to terminate the light exposure, charge is transferred from the vertical CCDs 152 and the horizontal CCD 153, and is output as video signals. The voltage applied to the substrate at this timing is VsubM1. In this example, VsubM1 is set such that the saturation level is at a predetermined level (600 mV in this example). Thus, the digital signal processor 120 calculates VsubM1 for setting the saturation level at a target level (i.e., 600 mV) based on the readout individual difference information in the control value calculation step, and outputs a control value to the D/A converter 130 at the timing shown in FIG. 4. In the example shown in FIG. 5, as VsubM1, VsubM1a is applied to the device A, whereas VsubM1b is applied to the device B. Accordingly, desired saturation performance can be obtained, irrespective of individual differences in dependence of saturation performance on the substrate voltage, thereby transferring and reading charge in optimum conditions.

The analog front end 110 converts the thus-output video signal (the analog signal) into a digital signal, and outputs the digital signal to the digital signal processor 120. The digital signal processor 120 performs image processing and compression on this video signal (the digital value), and outputs the resultant video signal to, for example, the recording system. In this manner, a video signal is recorded on a predetermined recording medium.

### Capture of Moving Image

In the mode of capturing a moving image, the imaging system 1 operates in the manner described below so as to control a substrate voltage to be applied to the solid-state image sensor device 150 (a substrate voltage application step).

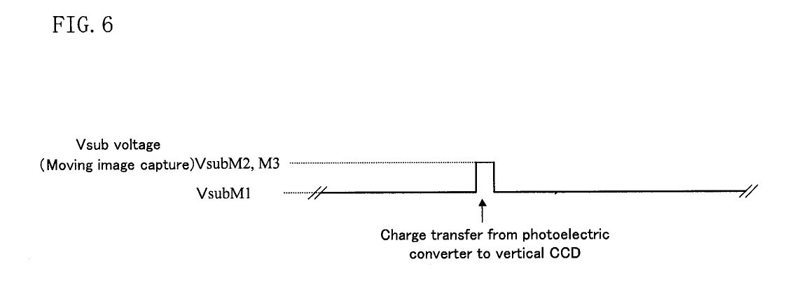

FIG. 6 is a timing chart showing voltages to be applied to the substrate at respective stages of image capture in the capture mode of a moving image and timings of application of the voltages. In this example, as shown in FIG. 6, in the capture mode of a moving image, VsubM1 is applied during light exposure, and VsubM2 or VsubM3 is applied in transferring charge from the photoelectric converters 151 to the vertical CCDs 152.

In this example, VsubM1 is set at the same voltage as in the mode of capturing a still image described above in order to allow spectral characteristics in the light exposure to be the same as those in capturing a still image. The digital signal processor 120 calculates VsubM1 for adjusting the saturation level necessary for a still image to the target level (i.e., 600 mV) based on the individual difference information readout in the control value calculation step, and outputs a control value to the D/A converter 130 at the timing shown in FIG. 6. In the example shown in FIG. 5, as VsubM1, VsubM1a is applied to the device A, whereas VsubM1b is applied to the device B. Accordingly, the same spectral characteristics as those in capturing a still image can also be obtained in capturing a moving image, thereby enabling common color signal processing to be performed for both a moving image and a still image and easily reproducing the color in the same manner.

One of VsubM2 and VsubM3 is selected according to the capture mode. For example, in some capture modes, signal charge from a plurality of pixels is added together (pixel binning) and the sum is output. In such a capture mode, the saturation level of the solid-state image sensor device 150 needs to be reduced in consideration of, for example, transfer capacity of the horizontal CCD 153.

Specifically, suppose the devices A and B have individual differences as shown in FIG. 5 in the case where the saturation level is intended to be set at 160 mV in an image capture mode (a six-pixel mixed mode) of a moving image in which signal charge of six pixels is mixed, and the signal charge is intended to be set at 80 mV in a capture mode (a nine-pixel mixed mode) of a moving image in which signal charge of nine pixels is mixed. Then, the digital signal processor 120 calculates, as a control value, VsubM2 or VsubM3 for adjusting the saturation level to the target level (i.e., 80 mV or 160 mV) in the control value calculation step based on the readout individual difference information, and outputs the control value to the D/A converter 130 at the timing shown in FIG. 6. In the example shown in FIG. 5, VsubM2a is applied to the device A in the six-pixel mixed mode, and VsubM3a is applied to the device A in the nine-pixel mixed mode. To the device B, VsubM2b is applied in the six-pixel mixed mode, and VsubM3b is applied in the nine-pixel mixed mode. In this manner, in the imaging system 1, in the capture mode of a moving image, desired saturation performance can be obtained, irrespective of individual differences in dependence of saturation performance on the substrate voltage, thereby enabling charge transfer not exceeding the transfer capacity of, for example, the horizontal CCD 153.

The analog front end 110 converts the thus-output video signal (an analog signal) into a digital signal, and outputs the digital signal to the digital signal processor 120. The digital signal processor 120 performs image processing and compression on this video signal (the digital value), and outputs the vide signal to, for example, the recording system. In this manner, a video signal is recorded on a predetermined recording medium.

As described above, in this embodiment, individual difference information indicating dependence of saturation performance on the substrate voltage in the solid-state image sensor device 150 is stored in the nonvolatile memory 180, and is output to the outside, thereby easily obtaining a substrate potential for desired saturation performance.

Consequently, desired saturation performance can be obtained, irrespective of individual differences in dependence of saturation performance on the substrate voltage. That is, maximum performance concerning saturation performance of the solid-state image sensor can be obtained for each capture mode, and further, a decrease in yield due to variation can be reduced.

### Second Embodiment

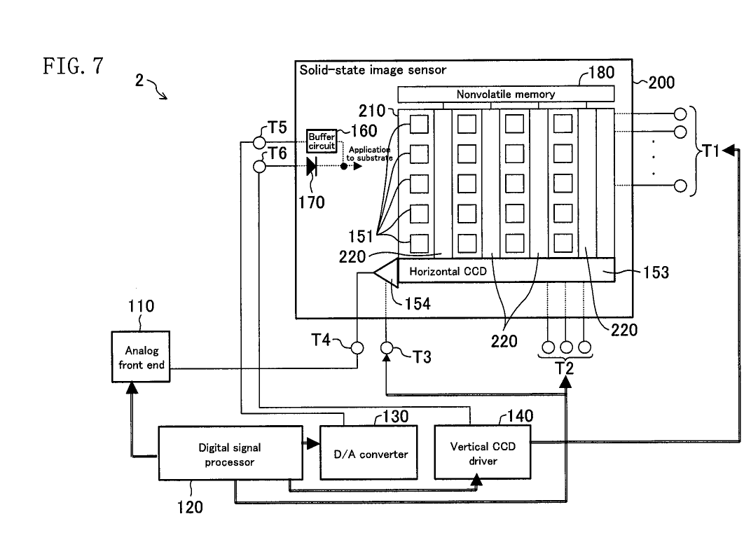

FIG. 7 is a block diagram illustrating a configuration of an imaging system 2 according to a second embodiment of the present invention. The imaging system 2 differs from that of the first embodiment in the configuration of a solid-state image sensor (i.e., a solid-state image sensor 200). Specifically, the solid-state image sensor 200 includes a buffer circuit 160, a clamp diode 170, a nonvolatile memory 180, and a solid-state image sensor device 210.

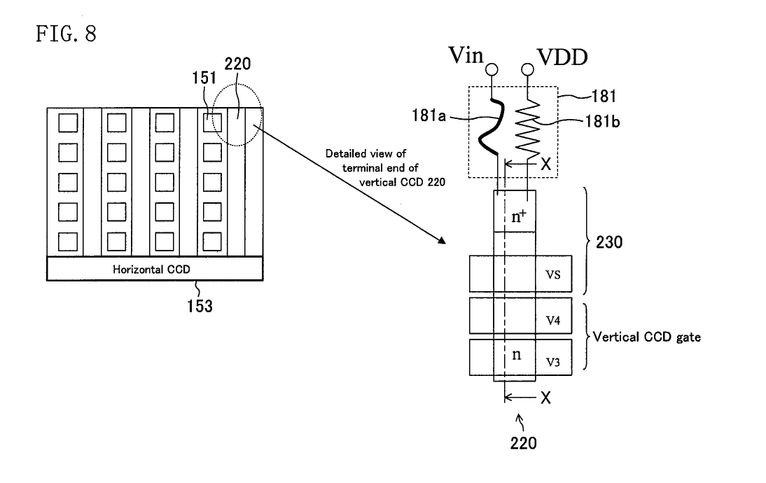

The solid-state image sensor device 210 includes photoelectric converters 151, vertical CCDs 220, a horizontal CCD 153, and an output amplifier 154. That is, in the solid-state image sensor device 210, the configuration of the vertical CCDs 220 differs from that of the first embodiment. Specifically, as illustrated in FIG. 8, in the vertical CCDs 220, charge injection units 230 each made of an n⁺ region and a gate electrode (i.e., a stop gate VS) are provided near the terminal end of the vertical CCDs (hereinafter referred to as vertical CCD body) which are similar to those in the first embodiment. In FIGS. 8, V3 and V4 denote gate electrodes provided in association with charge coupled devices in the vertical CCDs 220. In reading charge from the vertical CCDs 220, predetermined voltages are applied from a vertical CCD driver 140 to the gate electrodes V3 and V4 through vertical CCD driver terminals T1, in addition to gate electrodes V1 and V2 (not shown in FIG. 8) provided next to the gate electrode V3. The gate electrodes V1-V4 are also referred to as vertical CCD gates.

Memory cells 181 of a nonvolatile memory 180 are connected to n⁺ regions. In this example, each of the memory cells 181 includes a fuse 181a and a pull-up resistor 181b, and stores a digital value of 1 or 0 depending on whether the fuse 181a is blown or not. Specifically, in this embodiment, the fuse 181a has one end to which a voltage Vin is applied, and another end connected to the n⁺ region. The pull-up resistor 181b has one end to which a voltage VDD (e.g., a power supply voltage) is applied, and another end connected to the n⁺ region. With this configuration, when the fuse 181a is blown, a voltage VDD is applied to the n⁺ region. On the other hand, when the fuse 181a is in a conductive state, a voltage Vin is applied to the n⁺ region. Charge can be injected from the n⁺ region to the terminal end of each of the vertical CCDs 220 by setting the voltage Vin at an appropriate voltage. That is, whether the value stored in the memory cells 181 is 1 or 0 can be identified depending on whether charge injection from the n⁺ region to the terminal end of the vertical CCDs 220 is performed or not.

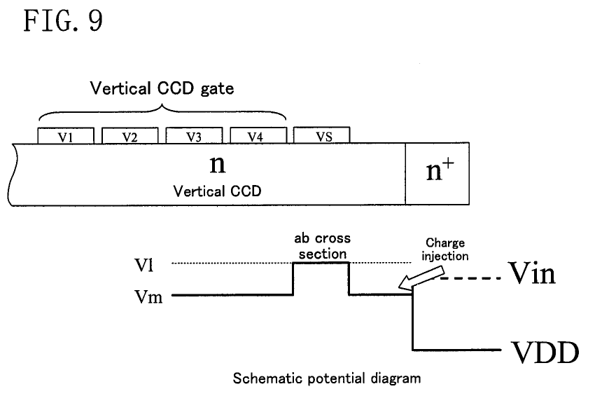

Charge in the n⁺ region is transferred to the body of each of the vertical CCDs 220 by applying a predetermined voltage to the stop gate VS. FIG. 9 schematically shows the n⁺ region of the vertical CCD 220 and potentials at the body of the vertical CCD 220. FIG. 9 shows the potential in the X-X cross section shown in FIG. 8. For example, in a state in which V1 (e.g., −7 V) lower than Vin is applied to the stop gate VS, charge from the n⁺ region cannot move toward the body of the vertical CCD 220. On the other hand, when Vm (e.g., 0 V) higher than Vin is applied to the stop gate VS, charge in the n⁺ region can move toward the body of the vertical CCD 220.

### Operation of Imaging System 2

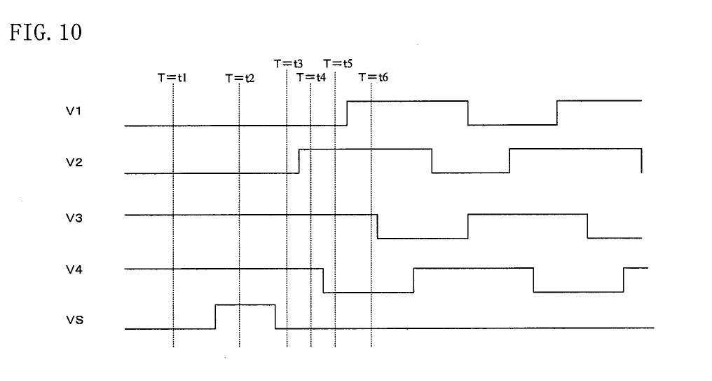

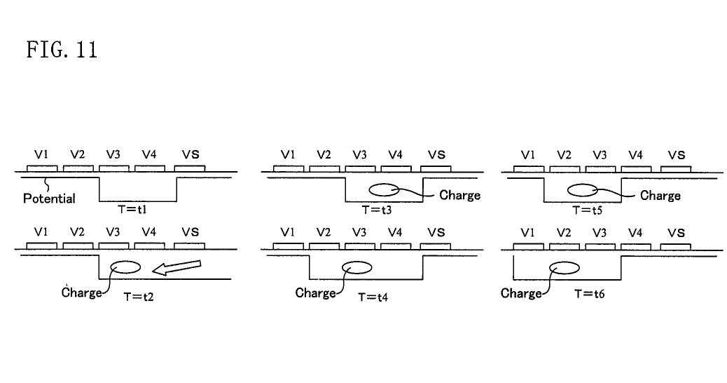

In the imaging system 2, readout operation of individual difference information in the readout step differs from that in the imaging system 1 of the first embodiment. Specifically, in the imaging system 2, readout of a value from the nonvolatile memory 180 is performed in the same manner as in readout of signal charge from the photoelectric converters 151, by utilizing the vertical CCDs 220, the horizontal CCD 153, and the output amplifier 154. FIG. 10 is a diagram showing voltages applied to the gate electrodes (V1-V4) of the body of the vertical CCD 220 and the stop gate VS. FIG. 11 shows potentials in the vertical CCD 220 and movement of charge in the vertical CCD 220.

For example, at time T=t1, the potential at the stop gate VS is high, and charge cannot flow into the body of the vertical CCD 220. In this state, when Vm is applied to the stop gate VS at time T=t2 as shown in FIG. 10, charge in the n⁺ region flows toward the gate electrodes V4 and V3 as shown in FIG. 11. Then, at time T=t3, when the voltage at the stop gate VS is set at V1, the charge which has flown into the body is confined between the gate electrodes V4 and V3.

Subsequently, when the potential at the gate electrode V2 is reduced at time T=t4, the charge which has flown into the body moves toward the gate electrode V2. Then, when the potential at the gate electrode V4 is increased at time T=t5, the charge is confined between the gate electrodes V3 and V2. Thereafter, when the potential at the gate electrode V1 is reduced at time T=t6, the charge moves toward the gate electrode V1. In the same manner, charge injected from the n⁺ region moves from the terminal end toward the start end in the vertical CCD 220. This charge is output to the horizontal CCD 153, and then to the output amplifier 154. The output amplifier 154 converts the input signal charge into a voltage, and outputs the voltage, as a signal voltage, to outside the solid-state image sensor 200 through a signal output terminal T4. That is, in this embodiment, individual difference information stored in the nonvolatile memory 180 is read out in the same manner as for a video signal in the row direction, by utilizing the vertical CCDs 220, the horizontal CCD 153, and the output amplifier 154 provided to read the video signal.

The thus-readout individual difference information is input to the analog front end 110, and converted into a digital signal, and the digital value is input to the digital signal processor 120. In this manner, the individual difference information can be used in the digital signal processor 120, and as in the imaging system 1 of the first embodiment, a substrate potential for desired saturation performance can be easily obtained.

In the manner described above, in this embodiment, since individual difference information is read out by utilizing the function of reading a video signal, the signal output terminal T4 can be used for outputting individual difference information, and unlike the first embodiment, the memory-data-readout-clock input terminal T9 is not needed. That is, the arrangement of terminals (i.e., pins) has compatibility with a conventional solid-state image sensor. In addition, in general, the circuit scale can be reduced as compared to the imaging system 1 of the first embodiment.

As described above, in this embodiment, the nonvolatile memory 180 needs to be connected to the vertical CCDs 220, and thus, the storage capacity is less than or equal to that corresponding to the number of columns of the solid-state image sensor devices. Accordingly, the imaging system 2 of this embodiment is considered to be suitable for the case where individual difference information can be stored with such a capacity, whereas the imaging system 1 of the first embodiment is considered to be suitable for the case where the storage capacity for individual difference information is needed. In addition, in the first embodiment, the circuit is made only of complete digital circuits, and thus, the circuit design can be easily performed.

### Other Embodiments

The nonvolatile memory 180 is not limited to the nonvolatile memory including the fuse and the pull-up resistor described in the above embodiments. Alternatively, the nonvolatile memory 180 may be a MONOS semiconductor device, for example.

The control value does not need to be previously obtained, and may be calculated by the digital signal processor 120 at every switching between capture modes.

A solid-state image sensor according to the present invention can easily obtain a substrate potential for desired saturation performance, and thus has the advantage of obtaining desired saturation performance irrespective of individual differences in dependence of saturation performance on the substrate voltage. Thus, the solid-state image sensor is useful as a so-called CCD solid-state image sensor and an imaging system for capturing images in various capture modes by using such a solid-state image sensor.

What is claimed is:

1. An imaging system, comprising:
a solid-state image sensor device including
a plurality of photoelectric converters arranged in rows and columns and configured to perform photoelectric conversion on incident light to output signal charge,
a plurality of vertical transfer units provided for the respective columns of the photoelectric converters and each configured to transfer, in a direction along the columns, signal charge output from part of the photoelectric converters in an associated one of the columns, and
a horizontal transfer output unit connected to ends of the respective vertical transfer units and configured to transfer signal charge output from the vertical transfer units in a direction along the rows to output the signal charge as a video signal;
a nonvolatile storage unit integrated on a substrate on which the solid-state image sensor device is integrated, configured to store individual difference information indicating individual differences in dependence of saturation performance on a substrate voltage in the solid-state image sensor device and output the stored individual difference information;
a substrate-voltage application unit configured to apply a voltage to the substrate on which the solid-state image sensor device is integrated; and
a control unit configured to control a voltage to be applied from the substrate-voltage application unit for each capture mode, according to individual difference information read out from the nonvolatile storage unit.

2. A solid-state image sensor, comprising:
a solid-state image sensor device including
a plurality of photoelectric converters arranged in rows and columns and configured to perform photoelectric conversion on incident light to output signal charge,
a plurality of vertical transfer units provided for the respective columns of the photoelectric converters and each configured to transfer, in a direction along the columns, signal charge output from part of the photoelectric converters in an associated one of the columns, and
a horizontal transfer output unit connected to ends of the respective vertical transfer units and configured to transfer signal charge output from the vertical transfer units in a direction along the rows to output the signal charge as a video signal; and
a nonvolatile storage unit integrated on a substrate on which the solid-state image sensor device is integrated, configured to store individual difference information indicating differences in dependence of saturation performance on a substrate voltage in the solid-state image sensor device and output the stored individual difference information, wherein
the nonvolatile storage unit includes a plurality of memory cells each including a fuse.

3. The solid-state image sensor of claim 2, further comprising a charge injection unit connected to the nonvolatile storage unit, and configured to inject the individual difference information as signal charge in the direction along the rows of the solid-state image sensor device from sides of the vertical transfer units serving as terminal ends of transfer, wherein
individual difference information injected as signal charge from the charge injection unit is transferred by the vertical transfer units and the horizontal transfer output unit, and is output from a terminal at which the video signal is output.

4. A method for driving a solid-state image sensor,
the solid-state image sensor including
a solid-state image sensor device including a plurality of photoelectric converters arranged in rows and columns and configured to perform photoelectric conversion on incident light to output signal charge, a plurality of vertical transfer units provided for the respective columns of the photoelectric converters and each configured to transfer, in a direction along the columns, signal charge output from part of the photoelectric converters in an associated one of the columns, and a horizontal transfer output unit connected to ends of the respective vertical transfer units and configured to transfer signal charge output from the vertical transfer units in a direction along the rows to output the signal charge as a video signal; and
a nonvolatile storage unit integrated on a substrate on which the solid-state image sensor device is integrated, configured to store individual difference information indicating individual differences in dependence of saturation performance on a substrate voltage in the solid-state image sensor device and output the stored individual difference information, and
the method comprising:
a readout step of reading the individual difference information from the nonvolatile storage unit;
a control value calculation step of obtaining a control value corresponding to a voltage to be applied to the substrate on which the solid-state image sensor device is integrated, according to the individual difference information read out in the readout step; and
a substrate voltage application step of applying a voltage corresponding to the control value obtained in the control value calculation step to the substrate on which the solid-state image sensor is integrated for each capture mode.
